(19) United States
(12) Patent Application Publication
(10) Pub. No.: US 2018/0191862 A1
(43) Pub. Date: Jul. 5, 2018

(54) DETECTION AND DELEGATION OF ACTION TASKS

(71) Applicant: Microsoft Technology Licensing, LLC, Redmond, WA (US)

(72) Inventors: Mark Encarnacion, Bellevue, WA (US); Ievgeniia Zhovtobriukh, Bothell, WA (US); Patrick Pantel, Bellevue, WA (US); Ahmed Awadallah, Redmond, WA (US); Chetan Bansal, Seattle, WA (US); Michael Gamon, Redmond, WA (US); Cem Aykan, Issaquah, WA (US); Michele Banko, Emerald Hills, CA (US); Mike Snow, Carnation, WA (US); Johannes Gehrke, Bellevue, WA (US)

(21) Appl. No.: 15/393,479

(22) Filed: Dec. 29, 2016

(51) Int. Cl. H04L 29/08

(52) U.S. Cl. CPC H04L 67/327; H04L 67/2804

(57) ABSTRACT

Systems and methods are presented for detecting an action intent within received content, identifying an action completion bot for carrying out the corresponding action, and initiating the action through an action request to the action completion bot. An action delegation agent executing on a computer system, receives notice of received content, where the action delegation agent is not the target of the received content. An analysis of the received content is conducted to identify an action intent of the received content. Based on the action intent, an action registry is consulted to identify a corresponding action completion bot for carrying out the intended action. A request is submitted to the action completion hot to carry out the action.

### BACKGROUND

In a network-connected world, people typically receive numerous communications each and every day. Some of the communications require the recipient to carry out one or more actions in response to receiving the communication. For example, a person may receive an email at work regarding the processing and payment of an attached receipt, which the recipient must then enter into the business' system and generate a payment check. More often than not, there are tools that the recipient uses to take care of all of the individual steps, but the recipient is the nexus of those activities and must initiate each task. There may be tools that automate the process, but the recipient nexus still remains—the recipient must investigate the communication, determine what action should be taken, and initiate one or more actions to carry out the requisite task.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods are presented for detecting an action intent within received content, identifying an action completion bot for carrying out the corresponding action, and initiating the action through an action request to the action completion hot. An action delegation agent executing on a computer system, receives notice of received content, where the action delegation agent is not the target of the received content. An analysis of the received content is conducted to identify an action intent of the received content. Based on the action intent, an action registry is consulted to identify a corresponding action completion bot for carrying out the intended action. A request is submitted to the action completion bot to carry out the action.

According to additional actions of the disclosed subject matter, a method for detecting and delegating a completion action in regard to received content is presented and disclosed. The method comprises receiving notice of received content at the computing device. An action to be taken is identified, where the action is identified according to the subject matter of the received content. An action completion bot suitable for carrying out the identified action is identified. An action request is generated, where the action request is for initiating the action by the identified action completion bot. The action request is then transmitted to the identified action completion bot for executing the identified action.

According to additional aspects of the disclosed subject matter, computer-readable media bearing computer-executable instructions which, when executed on a computing device comprising at least a processor, carry out a method for detecting and delegating a completion action, is presented. The method comprises receiving notice of received content at the computing device. An action to be taken is identified, where the action is identified according to the subject matter of the received content. An action completion bot suitable for carrying out the identified action is identified. An action request is generated, where the action request is for initiating the action by the identified action completion bot. The action request is then transmitted to the identified action completion bot for executing the identified action.

According to still further aspects of the disclosed subject matter, a computer system for detecting and delegating a completion action in response to receiving content is presented. The computer system comprises a processor and a memory, wherein the processor executes instructions stored in the memory as part of or in conjunction with additional executable components for delegating an action to an action completion bot in response to receiving content. The additional components include a content analysis component, a bot selection component, an action request component, and an action delegation agent. The content analysis component carries out an analysis of received content to identify an action intent of the received content, and the bot selection component carries out a selection of an action completion bot to implement an identified action intent of the received content. Still further, the action request component generates an action request for initiating an action by an action completion bot. Also, the action delegation agent is configured to receive notice of received content at the computing system. After receiving notice of the received content, the action delegation agent identifies an action to be taken according to the subject matter of the received content according to an action intent identified via the content analysis component. An action completion bot suitable for carrying out the identified action by way of the bot selection component is then identified, and an action request is generated for initiating the action by the identified action completion bot by way of the action request component. Finally, the action request is transmitted to the identified action completion bot for executing the identified action.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary network environment suitable for carrying out aspects of action detection and delegation with regard to received content;

FIG. 2 is a flow diagram illustrating an exemplary routine for receiving content and initiating action detection and delegation with regard to the content;

FIG. 3 is a flow diagram illustrating an exemplary routine for identifying action tasks within received content and delegating the actions to one or more corresponding action completion bots for execution of the actions;

FIG. 4 is a block diagram illustrating an exemplary computer readable medium encoded with instructions to detect actions within received content and delegating the actions to one or more corresponding action completion bots for execution of the actions; and

FIG. 5 is a block diagram illustrating an exemplary computing device suitable for implementing an aspects of the disclosed subject matter.

### DETAILED DESCRIPTION

For purposes of clarity and definition, the term “exemplary,” as used in this document, should be interpreted as serving as an illustration or example of something, and it should not be interpreted as an ideal or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

By way of definition, a “bot” corresponds to an executable service which, upon receiving a request, carries out a service and/or function on behalf of the requester. For purposes of this disclosure, a bot is accessed via an application programming interface (API) known and accessible to an action delegation agent operating on behalf of a computer user. An action completion bot is a bot that is configured to respond to an action request and carry out a requested action, as identified in the request. According to aspects of the disclosed subject matter, while an action completion bot receives an action request and acts upon it based on the subject matter of the request, for purposes of this disclosure an action completion bot is not the intended target of the received content at the computing device, for which the action completion agent identifies an action completion bot.

As will be described in greater detail below, the action delegation agent is not viewed as an action completion bot, but rather an agent to initiate actions with action completion on behalf of a computer user. Typically, though not exclusively, a action completion bot exists and operates independently of application that receives content on the computer user's computing device. According to aspects of the disclosed subject matter, an action completion bot may be a local bot, i.e., a local service executing on the computer user's computing device, or a remote bot, i.e., a remote service operating on a computing device accessible via a network. Further still and according to various aspects of the disclosed subject matter, an action completion bot may also correspond to an online, crowd-sourcing service or “mechanical turk” to carry out a requested action. By way of definition, a mechanical turk is crowdsourcing Internet marketplace that enables individuals (and/or businesses) to coordinate the use of human intelligence to perform tasks

According to aspects of the disclosed subject matter, an action delegation agent executing in conjunction with a computer user's computing device detects and/or is notified of content that is received at the computing device. According to aspects of the disclosed subject matter, the action delegation agent is not the target of the received content, i.e., the received content is directed to another application and/or service, typically (though not exclusively) an application or service available on the receiving computing device.

The action delegation agent examines the subject matter of the received content, and determines/detects whether one or more actions are to be taken in regard to receiving the content according to the examination of the subject matter. According to aspects of the disclosed subject matter, the determination may be based on a semantic analysis of the content, and matching the results of the analysis to an action intent as contained in an action registry comprising a plurality of action intent/bot pairs, each pair for carrying out a particular action. As one or more action completion hots may be configured to carry out a given action, a determination may also be made with regard to selecting an action completion hot from a plurality of action completion hots for carrying out the action and initiating the action with the selected hot. Additionally, the action delegation agent may select the various action completion bots according to a need to fill various slots corresponding to people, time, locations, etc.

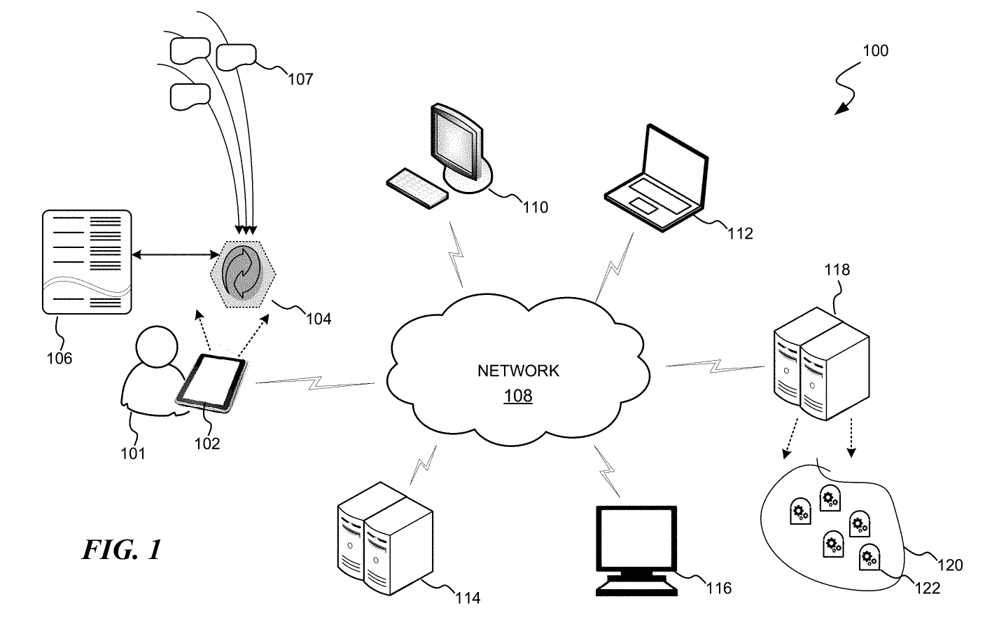

Turning now to the figures, FIG. 1 is a pictorial diagram illustrating an exemplary network environment 100 suitable for carrying out aspects of action detection and delegation with regard to received content. As discussed above, a computer user 101 operating a user computer 102, may receive content, e.g., content item 107, from a variety of sources, including third parties and/or services, as well as applications executing on the user's computing device 102. Operating in conjunction with the computing device, is an action delegation agent 104. In particular, upon the computer user 101 receiving content 107 (via the computing device 102), the action delegation agent 104 is notified.

As indicated above, the action delegation agent 104 is operating in conjunction with the computing device 102. According to aspects of the disclosed subject matter, the action delegation agent 104 may be executing wholly on the computing device 102, wholly on a computing device external to the computer user's computing device, or distributed on both the computer user's computing device as well as an external computing device. For purposes of simplicity in this disclosure, however, reference will be made as though the action delegation agent 104 is operating on the computer user's computing device 102. Also, the action delegation agent 104, in operating on the computing device 102, is independent of the target application or service of the received content on the computing device. In other words, content that is received is typically directed to a particular target application and/or service, such as an email is directed to an email application, a received spreadsheet may be directed to a spreadsheet application, etc. However, in contrast to the intended target of the received content, the action delegation agent 104 is generally not the intended target of the received content.

The user computer 102 is typically connected to a network 108 for communicating with one or more remote computer's and/or services. By way of illustration and not limitation, the network 108 may comprise any of a local area network (LAN), a wide area network (WAN), or combinations of the two. The network may comprise the well-known networks such as the Internet. Any or all of these remote computers/services may host one or more action completion bots, such as computing device 118 hosting a plurality 120 of action completion bots, including action completion bot 122. Further, while not shown, the user computer 102 may host one or more action completion bots. Further still, additional computing devices including computing device 110-116 may also host one or more action completion bots that may be utilized by the action delegation agent 104, as will be further described below.

Upon receiving content at the computer user's computing device 102, the action delegation agent 104 is notified. Notification may include information as to the specific content that is received, or direct access to the content for the action delegation agent 104. In turn, the action delegation agent 104 conducts an analysis of the content to determine whether a corresponding action should be taken. The analysis may be a semantic analysis to determine the intent of the content, or may be a search of the content for particular elements, tokens, and/or structures. Further still, the analysis may be in regard to the particular type of content that has been received, based on metadata regarding the received content and/or the particular application to which the content was directed.

After conducting an analysis (or examination) of the content, the action delegation agent 104 utilizes an action registry 106 that is comprises of a plurality of action intent/bot pairs, each pair for carrying out a particular action via a corresponding bot. The action registry 106 typically includes information regarding information for initiating the hot to carry out a particular action,

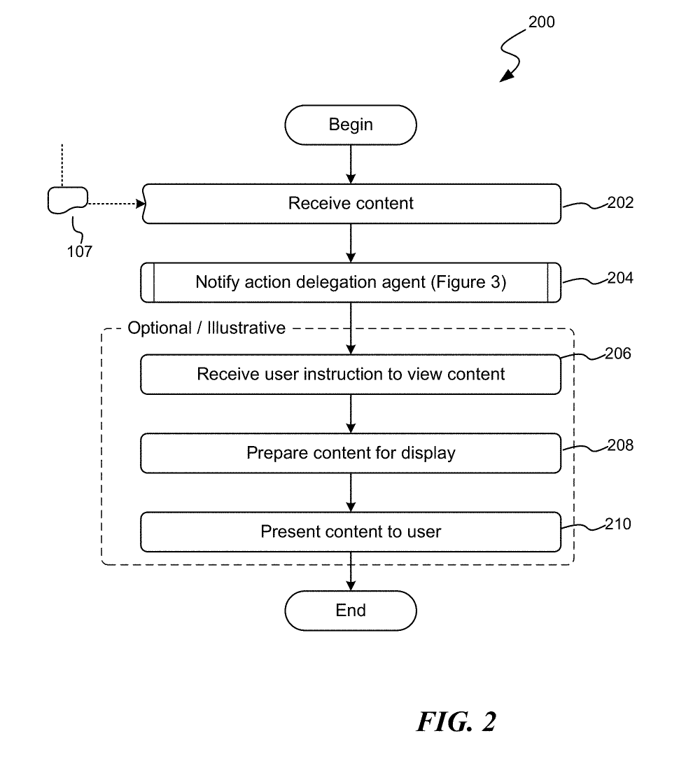

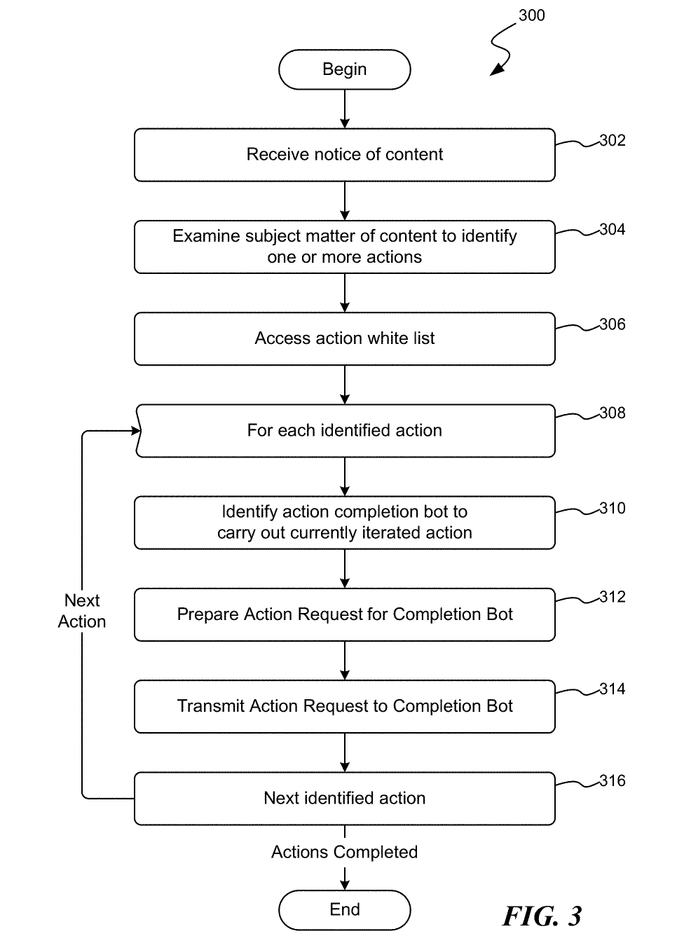

Turning to FIG. 2, FIG. 2 is a flow diagram illustrating an exemplary routine 200 for receiving content and initiating action detection and delegation with regard to the received content. Beginning at block 202, a computer user's computing device 102 receives content 107. At block 204, the action delegation agent 104 is notified of the received content which, in turns, processes the content in regard to potentially delegating an action to a suitable processing bot. Notifying the action delegation agent 104 is described in greater detail below in regard to FIG. 3.

As will be appreciated by those skilled in the art and according to various embodiments of the disclosed subject matter, while the action delegation agent 104 is notified of the received content, the action delegation agent may be configured to process received content independently and/or asynchronously of the execution of routine 200 or other actions that the computer user may take with regard to the received content 107. For example, after having notified the action delegation agent 104 of the received content 107, optionally and illustratively at block 206 the executing routine 200 may include receiving a computer user instruction to view the received content. At block 208, the received content is prepared for display to the computer user, and at block 201, the content is presented to the computer user. Thereafter, routine 200 terminates.

Turning to FIG. 3, FIG. 3 is a flow diagram illustrating an exemplary routine 300, as implemented by an action completion agent 104, for identifying action tasks within received content and delegating the actions to one or more corresponding action completion hots for execution of the actions. Beginning at block 302, the action completion agent 104 receives notice of received content 107. At block 304, the action completion agent 104 examines the subject matter of the received content to identify one or more actions, if any, to take with regard to the received content.

According to aspects of the disclosure subject matter, the identification or determination may be based on a semantic analysis of the received content 107, and matching the results of the analysis to an action intent as contained in an action registry 106 comprising a plurality of action intent/completion hot pairs, each pair suitable for carrying out a particular action. By way of illustration and not limitation and according to various embodiments, the analysis of the content may be a semantic analysis to determine one or more intents of the content. In another embodiment, the analysis may take the form of a search of the content for particular elements, tokens, and/or structures, as well as combinations of the same. Further still, in some embodiments, the analysis may be in regard to the particular type of content that has been received, based on metadata regarding the received content and/or the particular application to which the content was directed. Additionally or alternatively, and by way of illustration and not limitation, the analysis may be based on a combination of the various embodiments described above, such as the presence of particular tokens and/or data as well as identifying a semantic intent to take one or more actions.

After identifying one or more actions to be taken with regard to the received content 107, or as a result of receiving the content, the action registry 106 is accessed. According to aspects of the disclosed subject matter, accessing the action registry may comprise accessing a locally maintained list or registry of action intent/bot pairs, with each pair identifying one or more actions that a corresponding action completion bot may complete and the corresponding action completion bot for carrying out the identified action(s). Alternatively, accessing the action registry may comprise accessing a remote action registry that is maintained for the purpose of identifying various action completion bots and their corresponding actions.

At block 308, an iteration of the various identified actions, if any, is begun. The iteration comprises processing each of the identified actions according to the steps identified in blocks 308-316. Thus, at block 310, for a currently iterated identified action, an action completion bot is identified in the action registry 106 to carry out the currently identified action. As suggested above, the action registry 106 may include more than one action/completion bot pair that may be able to carry out the identified action. Accordingly, in various embodiments, identifying an action completion bot to carry out the currently iterated identified action may comprise selecting an action completion bot from among a plurality of action completion bots. This selection may be based on any number of factors including, by way of illustration and not limitation, whether the action completion bot is local to the computing device or remotely located, the processing bandwidth of the various action completion bots, pecuniary costs of the completion bot services, known user preferences, and the like.

At block 312, after having selected an action completion bot for carrying out the identified action, an action request is prepared for the action completion hot. Typically but not exclusively, preparation of the action request may be based on information in the action registry 106, or based on information dynamically obtained or cached with regard to the selected action completion hot. According to various embodiments of the disclosed subject matter, the action request may include all or some of the received content in order to provide sufficient data and/or information for completing the action. After preparing the action request, at block 314 the action request is transmitted to the selected action completion bot, such as action completion bot 122. According to aspects of the disclosed subject matter and in various embodiments, the request to the action completion bot is an asynchronous request such that processing may continue without awaiting completion of the identified actions. Of course, in an alternative embodiment, the request may be synchronous, requiring completion of the identified action before additional processing of routine 300 may continue. A determination of whether an action is to be carried out synchronously or asynchronously may be based on the particular identified action, and/or specified in the action registry 106,

At block 316, if there are any additional actions to be taken in the iteration, the routine 300 returns to block 308 where the next identified action is utilized for iteration and the process repeats as described above. Alternatively, at block 316 if there are no more identified actions to process, the routine 330 terminates.

Regarding routines 200 and 300 described above, as well as other processes described herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions steps are encoded.

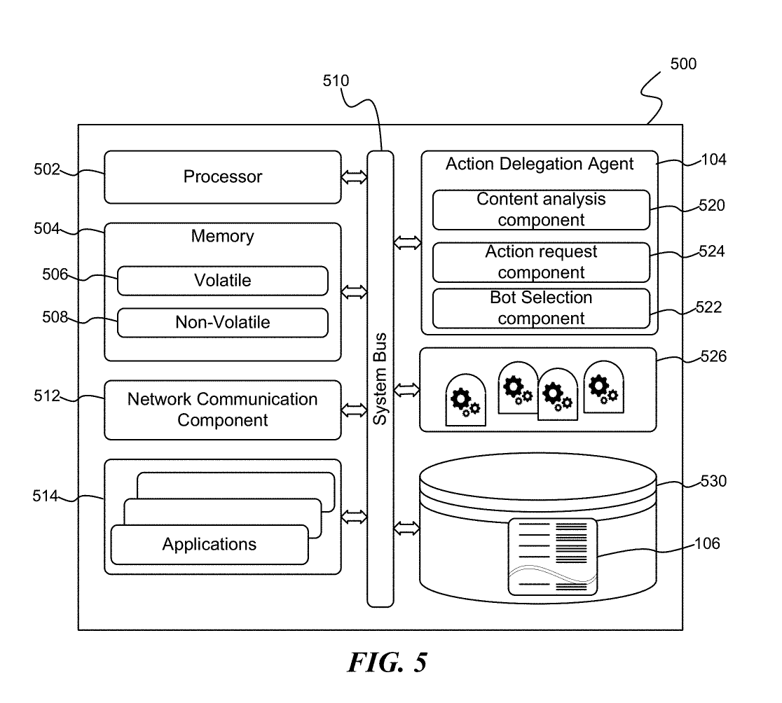

Of course, while the routines and/or processes include various novel features of the disclosed subject matter, other steps (not listed) may also be included and carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 5 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines and/or processes are typically embodied within executable code modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer readable media include, but are not limited to: optical storage media such as Blu ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer readable media may reproduce and/or cause to deliver the computer executable instructions and data to a computing device for execution by one or more processors via various transmission means and mediums, including carrier waves and/or propagated signals, for purposes of this disclosure computer readable media expressly excludes carrier waves and/or propagated signals.

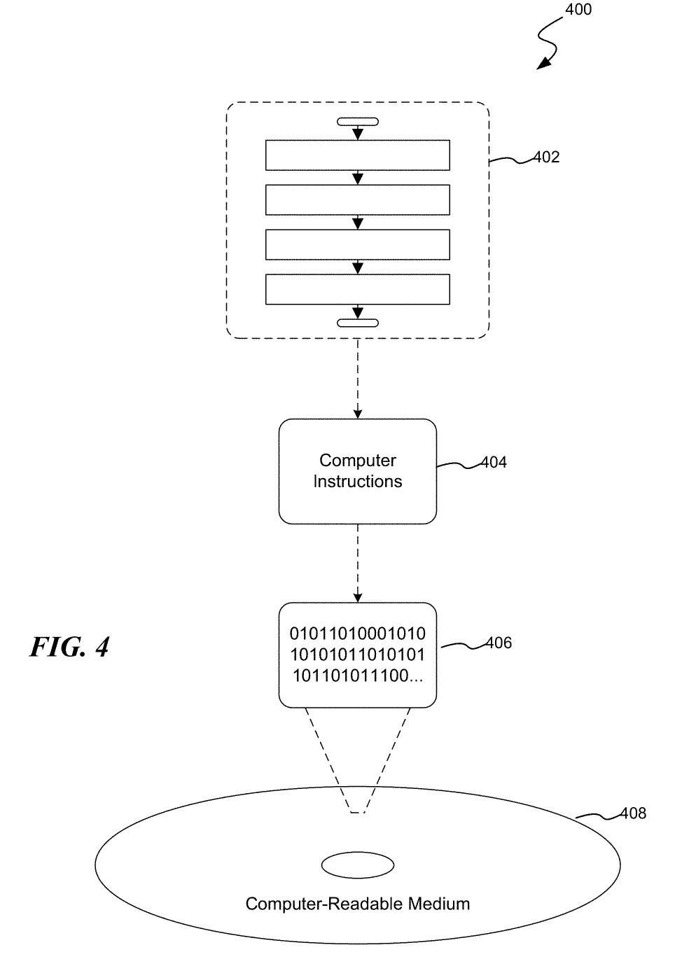

FIG. 4 is a block diagram illustrating an exemplary computer readable medium encoded with instructions to detect actions within received content and delegating the actions to one or more corresponding action completion bots for execution of the actions, as described above. More particularly, the implementation 400 comprises a computer-readable medium 408 (e.g., a CD-R, DVD-R or a platter of a hard disk drive), on which is encoded computer-readable data 406. This computer-readable data 406 in turn comprises a set of computer instructions 404 configured to operate according to one or more of the principles set forth herein. In one such embodiment 402, the processor-executable instructions 404 may be configured to perform a method, such as at least some of the exemplary methods 200 and/or 300, for example. In another such embodiment, the processor-executable instructions 404 may be configured to implement a system, such as at least some of the exemplary system 500, as described below. Many such computer readable media may be devised, by those of ordinary skill in the art, which are configured to operate in accordance with the techniques presented herein.

Turning now to FIG. 5, FIG. 5 is a block diagram illustrating an exemplary computing device 500 suitable for implementing aspects of the disclosed subject matter, particularly in regard to providing an action delegation agent that identifies and delegates actions to action completion bots based on received content.

The exemplary computing device 500 includes one or more processors (or processing units), such as processor 502, and a memory 504. The processor 502 and memory 504, as well as other components, are interconnected by way of a system bus 510. The memory 504 typically (but not always) comprises both volatile memory 506 and non-volatile memory 508. Volatile memory 506 retains or stores information so long as the memory is supplied with power. In contrast, non-volatile memory 508 is capable of storing (or persisting) information even when a power supply is not available. Generally speaking, RAM and CPU cache memory are examples of volatile memory 506 whereas ROM, solid-state memory devices, memory storage devices, and/or memory cards are examples of non-volatile memory 508.

As will be appreciated by those skilled in the art, the processor 502 executes instructions retrieved from the memory 504 (and/or from computer readable media, such as computer readable media 400 of FIG. 4) in carrying out various functions of providing an action delegation agent that identifies and delegates actions to action completion bots based on received content, as set forth above. The processor 502 may be comprised of any of a number of available processors such as single-processor, multi-processor, single-core units, and multi-core units.

Further still, the illustrated computing device 500 includes a network communication component 512 for interconnecting this computing device with other devices and/or services over a computer network, including other user devices. The network communication component 512, sometimes referred to as a network interface card or NIC, communicates over a network using one or more communication protocols via a physical/tangible (e.g., wired, optical, etc.) connection, a wireless connection, or both. As will be readily appreciated by those skilled in the art, a network communication component, such as network communication component 512, is typically comprised of hardware and/or firmware components (and may also include or comprise executable software components) that transmit and receive digital and/or analog signals over a transmission medium (i.e., the network.)

Also illustrated in the exemplary computing device 500 are one or more user-executable applications 514. As will be appreciated, an application, also called a software application, is a computer program designed to perform a group of coordinated functions, tasks, or activities for the benefit of the user. Applications include word processing applications, spreadsheet applications, drawing applications, email applications, messaging applications, Internet browsing applications, and the like. Operating system programs and drivers may also be viewed as software applications as they, too perform coordinated functions and/or tasks. All or some of these applications may receive content, either from other applications on the computing device and/or from remotes sources.

The exemplary computing device 500 also includes an action delegation agent 104. As described above, in execution the action delegation agent 104 is notified of received content 107 at the computing device, identifies one or more actions to take with regard to and in light of receiving the content, further identifies an action completion bot for carrying out each of the identified actions, and delegates the action to the action completion bots. The action delegation agent 104 includes a content analysis component 520 that, via execution, is utilized to analyze received content to identify any actions to be executed in light of receiving content. The action delegation component 104 also includes a bot selection component 522. In execution, the bot selection component accesses an action registry 106 to identify and select a bot for each of the one or more actions that are identified by the content analysis component 520. As indicated above, the action registry 106 may reside locally, such as in data store 530, on a remote network site, or as a combination of both local and remote portions of the registry. Still further, the action delegation agent 104 includes an action request component 524 that, in execution, generates actions requests for action completion bots and transmits the requests to the action completion bots, thereby invoking the action to be taken. Action completion bots may be executing locally on the exemplary computing device, such as action completion bots 526, or executing on remote devices, such action completion bots 120 executing on computing device 118.

Regarding the various components of the exemplary computing device 500, those skilled in the art will appreciate that many of these components may be implemented as executable software modules stored in the memory of the computing device, as executable hardware modules and/or components (including SoCs—system on a chip), or a combination of the two. Indeed, components may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions and features described herein.

Moreover, in certain embodiments each of the various components of the exemplary computing device 500 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network as in known in the art.

While much of the disclosed subject matter has been described in regard to carrying out one or more actions based on received content, it should be appreciated that the action completion agent 104 may be further suitably configured to carry out one or more actions based on content that may be sent from the computing device. For example, the action completion agent 104 may detect that an email is sent from the computing device to another user on a remotely located computing device. Upon detection of the email content being sent, the action completion agent 104 may examine the subject matter of the sent content, determine whether one or more actions should be taken, and carry out the actions as appropriate. By way of illustration and not limitation, the action completion agent 104 may detect that a file is sent to various recipients, detect/determine that an intent is to record the transmission of the content in a “sent log” based on analysis of the content (the identified action), locate an action completion bot suitable for implementing the identified action, and initiate the action with the identified action completion bot via an action request.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for detecting and delegating a completion action in regard to received content, the method comprising:
receiving notice of received content at the computing device;
identifying an action to be taken according to the subject matter of the received content;
identifying an action completion bot suitable for carrying out the identified action;
generating an action request for initiating the action by the identified action completion bot; and
transmitting the action request to the identified action completion bot for executing the identified action.

2. The computer-implemented method of claim 1, wherein the action delegation agent is independent of the received content target.

3. The computer-implemented method of claim 2, wherein identifying an action to be taken according to the subject matter of the received content comprises identifying the action according to a semantic analysis of the subject matter of the received content.

4. The computer-implemented method of claim 2, wherein identifying an action to be taken according to the subject matter of the received content comprises searching the received content for the presence of a combination of one or more elements, tokens and structures.

5. The computer-implemented method of claim 2, wherein identifying an action to be taken according to the subject matter of the received content comprises examining the metadata of the received content with regard to the target of the received content.

6. The computer-implemented method of claim 3, wherein identifying an action to be taken according to the subject matter of the received content further comprises matching the results of the semantic analysis to one of a plurality of action intents, the matched action intent being the identified action.

7. The computer-implemented method of claim 6, wherein the plurality of action intents are listed in an action registry, the action registry comprising the plurality of action intents with a corresponding plurality of action completion hots, each action completion bot suitable for carrying out the corresponding action intent.

8. The computer-implemented method of claim 7, wherein generating an action request for initiating the action by the identified action completion hot comprises providing at least a portion of the received content in the action request.

9. The computer-implemented method of claim 8, wherein the identified action completion bot is executing on the computing device.

10. The computer-implemented method of claim 8, wherein the identified action completion hot is executing on a remotely located computing device, and wherein transmitting the action request to the identified action completion bot comprises transmitting the action request over a network to the identified action completion bot.

11. A computer-readable medium bearing computer-executable instructions which, when executed on a computing device comprising at least a processor, carry out a method for detecting and delegating a completion action, the method comprising:
receiving notice of received content at the computing device;
identifying an action to be taken according to the subject matter of the received content;
identifying an action completion bot suitable for carrying out the identified action;
generating an action request for initiating the action by the identified action completion hot; and
transmitting the action request to the identified action completion bot for executing the identified action.

12. The computer-readable medium of claim 11, wherein identifying an action to be taken according to the subject matter of the received content comprises identifying the action according to a semantic analysis of the subject matter of the received content.

13. The computer-readable medium of claim 11, wherein identifying an action to be taken according to the subject matter of the received content comprises searching the received content for the presence of a combination of one or more elements, tokens and structures.

14. The computer-readable medium of claim 11, wherein identifying an action to be taken according to the subject matter of the received content comprises any one or more of identifying the action according to a semantic analysis of the subject matter of the received content and searching the received content for the presence of a combination of one or more elements, tokens and structures.

15. The computer-readable medium of claim 14, wherein identifying an action to be taken according to the subject matter of the received content further comprises examining the metadata of the received content with regard to the target of the received content.

16. The computer-readable medium of claim 14, wherein identifying an action to be taken according to the subject matter of the received content further comprises matching the results of the semantic analysis to one of a plurality of action intents, the matched action intent being the identified action.

17. The computer-readable medium of claim 16, wherein the plurality of action intents are listed in an action registry, the action registry comprising the plurality of action intents with a corresponding plurality of action completion bots, each action completion bot suitable for carrying out the corresponding action intent.

18. The computer-readable medium of claim 17, wherein generating an action request for initiating the action by the identified action completion bot comprises providing at least a portion of the received content in the action request.

19. The computer-readable medium of claim 18, wherein the identified action completion bot is executing on a remotely located computing device, and wherein transmitting the action request to the identified action completion bot comprises transmitting the action request over a network to the identified action completion bot.

20. A computer system for detecting and delegating a completion action in response to receiving content, the system comprising a processor and a memory, wherein the processor executes instructions stored in the memory as part of or in conjunction with additional executable components for delegating an action to an action completion bot in response to receiving content, the additional components comprising:
a content analysis component that, in execution on the computer system, carries out an analysis of received content to identify an action intent of the received content;
a bot selection component that, in execution on the computer system, carries out a selection of an action completion bot to implement an identified action intent of the received content;
an action request component that, in execution on the computer system, generates an action request for initiating an action by an action completion bot; and
an action delegation agent that, in execution on the computer system, is configure to:
receive notice of received content at the computing system;
identify an action to be taken according to the subject matter of the received content according to an action intent identified via the content analysis component;
identify an action completion bot suitable for carrying out the identified action by way of the bot selection component;
generate an action request for initiating the action by the identified action completion bot by way of the action request component; and
transmits the action request to the identified action completion bot for executing the identified action.
